(19) United States
(12) Patent Application Publication
(10) Pub. No.: US 2026/0217394 A1
(43) Pub. Date: Jul. 30, 2026

(54) Flybar Apparatus

(71) Applicant: University of Washington, Seattle, WA (US)

(72) Inventors: Kyle Christopher Wynn Johnson, Seattle, WA (US); Vikram Subramaniam Iyer, Seattle, WA (US); Vicente Arroyos, Seattle, WA (US); Sawyer B. Fuller, Seattle, WA (US); Adrianna Schulz, Seattle, WA (US); Raul Villanueva, Seattle, WA (US)

(21) Appl. No.: 19/140,171

(22) PCT Filed: Dec. 20, 2023
(86) PCT No.: PCT/US2023/085085

§ 371 Date: Jun. 17, 2025

Related U.S. Application Data
(60) Provisional application No. 63/434,011, filed on Dec. 20, 2022.

(51) Int. Cl. B64U 30/293; B32B 5/02; B32B 7/12; B32B 27/12; B32B 27/28; B64C 27/06; B64C 27/43; B64F 5/10; B64U 10/17; B64U 30/298

(52) U.S. Cl. CPC B64U 30/293; B32B 5/02; B32B 7/12; B32B 27/12; B32B 27/281; B64C 27/06; B64C 27/43; B64F 5/10; B64U 10/17; B64U 30/298; B32B 2262/106; B32B 2605/18

(57) ABSTRACT

An apparatus includes a rotor plate that includes a first flexure hinge configured for coupling to a drive shaft, and one or more rotor blades extending from the rotor plate. The first flexure hinge is configured to allow a first rotation axis of the one or more rotor blades to move out of alignment with the drive shaft. The apparatus also includes a flybar plate including a second flexure hinge configured for coupling to the drive shaft, and a flybar including a first flybar section and a second flybar section both extending from the flybar plate. The second flexure hinge is configured to allow a second rotation axis of the flybar to move out of alignment with the drive shaft.

### CROSS-REFERENCE TO RELATED APPLICATIONS

This application claims priority to U.S. Provisional Patent Application No. 63/434,011, filed on Dec. 20, 2022, the entire contents of which are incorporated by reference herein.

### STATEMENT REGARDING FEDERALLY SPONSORED RESEARCH OR DEVELOPMENT

This invention was made with government support under Grant No. FRR-2054850, awarded by the National Science Foundation and Grant No. 1000304407, awarded by the NSF Graduate Research Fellowship Program. The government has certain rights in the invention

### BACKGROUND

Small flying robots are useful for many tasks, such as search and rescue, precision agriculture, and environmental monitoring. However, the lift-to-weight ratio of a small flying robot is generally limited. Maintaining a stable orientation during flight is also typically difficult for a small flying robot.

### SUMMARY

A first example is an apparatus comprising: a rotor plate comprising a first flexure hinge configured for coupling to a drive shaft; one or more rotor blades extending from the rotor plate, wherein the first flexure hinge is configured to allow a first rotation axis of the one or more rotor blades to move out of alignment with the drive shaft; a flybar plate comprising a second flexure hinge configured for coupling to the drive shaft; and a flybar comprising a first flybar section and a second flybar section both extending from the flybar plate, wherein the second flexure hinge is configured to allow a second rotation axis of the flybar to move out of alignment with the drive shaft.

A second example is an aircraft comprising: the drive shaft of the first example; the one or more rotor blades of the first example attached to the drive shaft; an actuator configured to rotate the drive shaft; and the apparatus of the first example, wherein the drive shaft is coupled to the rotor plate via the first flexure hinge and the drive shaft is coupled to the flybar plate via the second flexure hinge.

A third example is a method of manufacturing the apparatus of the first example, the method comprising: forming the rotor plate and the one or more rotor blades as a first singular structure from a composite laminate structure that comprises: a first fibrous sheet; a second fibrous sheet; and a flexible film adhered to and between the first fibrous sheet and the second fibrous sheet, wherein forming the rotor plate and the one or more rotor blades comprises cutting through the first fibrous sheet, the second fibrous sheet, and the flexible film; forming the first flexure hinge within the rotor plate by cutting through the first fibrous sheet and the second fibrous sheet and leaving the flexible film intact; forming the first flybar section from the composite laminate structure by cutting through the first fibrous sheet, the second fibrous sheet, and the flexible film; forming the second flybar section from the composite laminate structure by cutting through the first fibrous sheet, the second fibrous sheet, and the flexible film; forming the flybar plate, the first linkage, and the second linkage as a second singular structure by cutting through the first fibrous sheet, the second fibrous sheet, and the flexible film; and forming the second flexure hinge by cutting through the first fibrous sheet and the second fibrous sheet and leaving the flexible film intact.

The contents of the following documents are incorporated by reference herein: Johnson, Kyle et al. “Toward Sub-gram Helicopters: Designing a Miniaturized Fly bar for Passive Stability.” (2023); https://faculty.washington.edu/minster/files/johnson_arroyos_villanueva_schultz_fuller_iyer_Flybar_iros2023.pdf.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of an aircraft, according to an example.

FIG. 2 is a perspective view of an apparatus, according to an example.

FIG. 3 is a close up perspective view of an apparatus, according to an example.

FIG. 4 is an exploded view of a composite laminate structure, according to an example.

FIG. 5 shows how portions of a composite laminate structure are cut and folded to form an apparatus, according to an example.

FIG. 6 shows cut lines for components of an apparatus that are cut from a composite laminate structure, according to an example.

FIG. 7 is a top schematic view of a flexure hinge, according to an example.

FIG. 8 is a bottom schematic view of a flexure hinge, according to an example.

FIG. 9 is a top schematic view of a flexure hinge, according to an example.

FIG. 10 is a bottom schematic view of a flexure hinge, according to an example.

FIG. 11 is a block diagram of a method, according to an example.

### DETAILED DESCRIPTION

A need exists for small flying robots that are held aloft with a single large motor-driven propeller rather than two or more smaller motor-driven propellers, that are nevertheless capable of holding a stable orientation during flight. Using a single motor provides higher efficiency and lower mass because of how forces and heat dissipation scale in coil-driven electromagnetic devices. Accordingly, this disclosure includes an apparatus for use in conjunction with an aircraft such as a small helicopter.

The apparatus includes a rotor plate that includes a first flexure hinge configured for coupling to a drive shaft, and one or more rotor blades extending from the rotor plate. The first flexure hinge is configured to allow a first rotation axis of the one or more rotor blades to move out of alignment with the drive shaft. The apparatus also includes a flybar plate that includes a second flexure hinge configured for coupling to the drive shaft, and a flybar that includes a first flybar section and a second flybar section both extending from the flybar plate. The second flexure hinge is configured to allow a second rotation axis of the fly bar to move out of alignment with the drive shaft.

Thus, when the aircraft experiences a disturbance such as a wind that applies an unexpected torque to the aircraft, the apparatus can help the aircraft mitigate and recover from the disturbance. Much of the mass of the flybar is distributed at opposite ends of the fly bar. The fly bar also rotates in unison with the rotor blades. Thus, when an unexpected torque is applied to the aircraft, the gyroscopic inertia of the flybar tends to keep the rotation plane of the flybar unchanged. The rotation plane of the fly bar and the rotation plane of the rotor blades are flexibly coupled via the first flexure hinge, the drive shaft, and the second flexure hinge. Thus, the rotor blades are allowed to passively pitch with respect to the drive shaft and/or the flybar in a way that helps the aircraft recover from the disturbance. In the absence of the disturbance, the flexure hinges can also operate to restore a condition where the rotation planes of the flybar and the rotor blades are substantially normal to the drive shaft. This is in contrast to a situation where the rotor blades have a static pitch with respect to the aircraft and generally do not aid in recovering the aircraft from the disturbance.

As the one or more rotor blades rotate about the drive shaft, the fly bar controls an angle of attack of the one or more rotor blades as a function of the rotation angle of the one or more rotor blades. As such, the lift provided by a rotor blade varies as a function of the rotational position of the rotor blade. For example, if the main body of the aircraft is rolled to the right by a small amount, the effect of the flybar is to cause a righting motion to roll it back leftward. To do this, the rotor plate must increase lift for a rotor blade if it is on the right, and decrease the lift when the rotor blade is on the left side of the aircraft. There is a gyroscopic effect from the one or more rotor blades spinning fast, so the fly bar additionally applies a torque perpendicular to the roll axis, that is, a pitch torque, so that, through precession, a roll motion results.

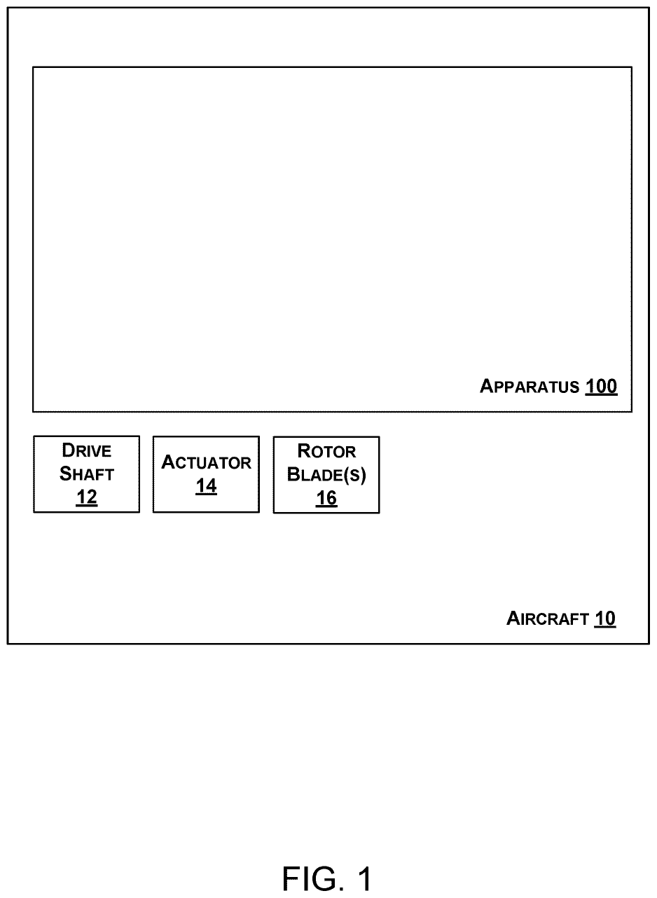

FIG. 1 is a block diagram of an aircraft 10. The aircraft 10 can take the form of a small (e.g., millimeter scale) helicopter, but other examples are possible. The aircraft 10 includes an apparatus 100, a drive shaft 12, an actuator 14, and one or more rotor blades 16.

The drive shaft 12 is generally rigid and cylindrically shaped, and configured to transfer rotational motion of the actuator 14 to the one or more rotor blades 16. In various examples, the drive shaft 12 is formed of one or more of metal, plastic, or carbon fiber composite.

The actuator 14 typically takes the form of an electric motor that converts electric energy provided by a battery to a torque applied to the drive shaft 12. In some examples, the actuator 14 could be an internal combustion engine or be powered by a hydrogen fuel cell. Other examples are possible.

The one or more rotor blades 16 are generally formed of metal, plastic, carbon fiber composite, or a composite laminate structure. The one or more rotor blades 16 are attached to the drive shaft 12 such that the actuator 14 can rotate the one or more rotor blades 16. The one or more rotor blades 16 in turn provide lift for the aircraft 10.

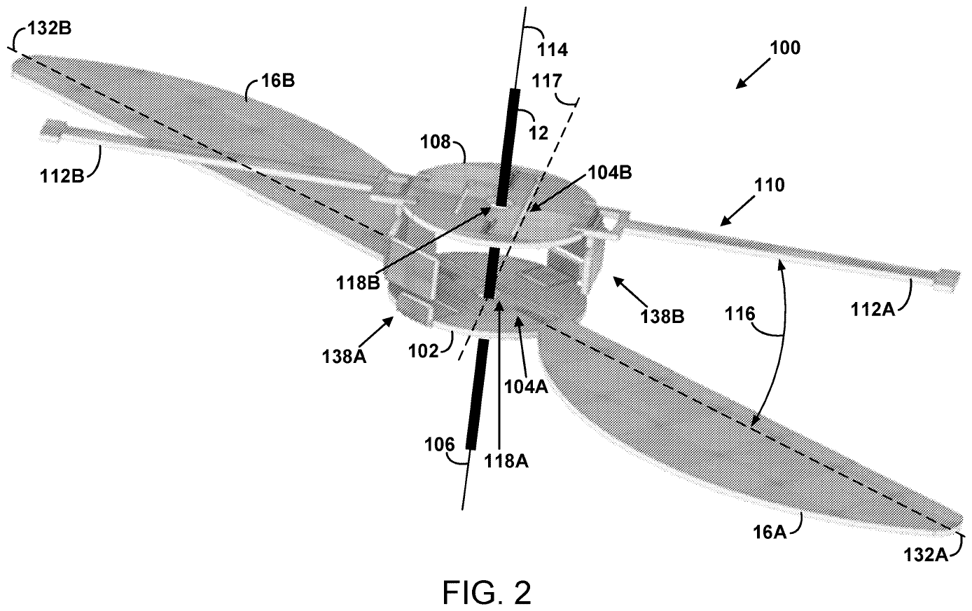

FIG. 2 is a perspective view of the apparatus 100. The apparatus 100 includes a rotor plate 102 comprising a flexure hinge 104A configured for coupling to the drive shaft 12. That is, the flexure hinge 104A couples the rotor plate 102 to the drive shaft 12. The apparatus 100 also includes a rotor blade 16A and a rotor blade 16B (i.e., the rotor blades 16) that extend outward from the rotor plate 102. The flexure hinge 104A is configured to allow a rotation axis 106 of the rotor blades 16 to move out of alignment with the drive shaft 12. However, in FIG. 2 the rotation axis 106 is shown in alignment with the drive shaft 12. The apparatus 100 also includes a flybar plate 108 comprising a flexure hinge 104B configured for coupling to the drive shaft 12. That is, the flexure hinge 104B couples the fly bar plate 108 to the drive shaft 12. The apparatus 100 also includes a flybar 110 comprising a flybar section 112A and a flybar section 112B that both extend outward from the fly bar plate 108. The flexure hinge 104B is configured to allow a rotation axis 114 of the flybar 110 to move out of alignment with the drive shaft 12. However, in FIG. 2 the rotation axis 114 is shown in alignment with the drive shaft 12. The rotation axis 106 is normal to a plane within which the rotor blades 16 rotate. The rotation axis 114 is normal to a plane within which the flybar 110 rotates.

The rotor blades 16 are coupled to the flybar 110 via the flexure hinge 104A, the drive shaft 12, and the flexure hinge 104B such that the rotor blades 16 and the flybar 110 are configured to rotate in unison with the same angular velocity as the drive shaft 12. The rotor plate 102 is also coupled to the fly bar plate 108 via a linkage 138A and a linkage 138B. The drive shaft 12 can be coupled to the rotor plate 102 at the hole 118A via adhesive (or another bonding mechanism) applied between the hole 118A and the rotor plate 102. The drive shaft 12 can be coupled to the flybar plate 108 at the hole 118B via adhesive (or another bonding mechanism) applied between the hole 118B and the flybar plate 108. As shown, the drive shaft 12 passes through the hole 118A and the hole 118B.

In FIG. 2, the rotor blades 16 are each rotationally offset from the flybar 110 by an angle 116 that is greater than or equal to 0 degrees and less than or equal to 90 degrees (e.g., greater than or equal to 45 degrees and less than or equal to 90 degrees), but other examples are possible.

The linkage 138A and/or the linkage 138B couple the flybar plate 108 to the rotor plate 102 such that tilting of the rotation axis 114 with respect to the drive shaft 12 results in tilting of the rotation axis 106 with respect to the drive shaft 12, such that an angle of attack of the one or more rotor blades can vary as the drive shaft rotates. The tilting of the rotation axis 106 is configured to occur within a first plane that contains the drive shaft 12 and the tilting of the rotation axis 114 is configured to occur within a second plane that contains the drive shaft 12 and intersects the first plane (e.g., at an angle of 0 to 45 degrees or 0 to 90 degrees). In other words, the rotor plate 102 and the rotor blades 16 are configured to tilt with respect to the drive shaft 12 along a chord 132A of the rotor blade 16A and a chord 132B of the rotor blade 16B. Additionally, the flybar plate 108 is configured to tilt with respect to the drive shaft 12 along a line 117 that is perpendicular to the flybar 110.

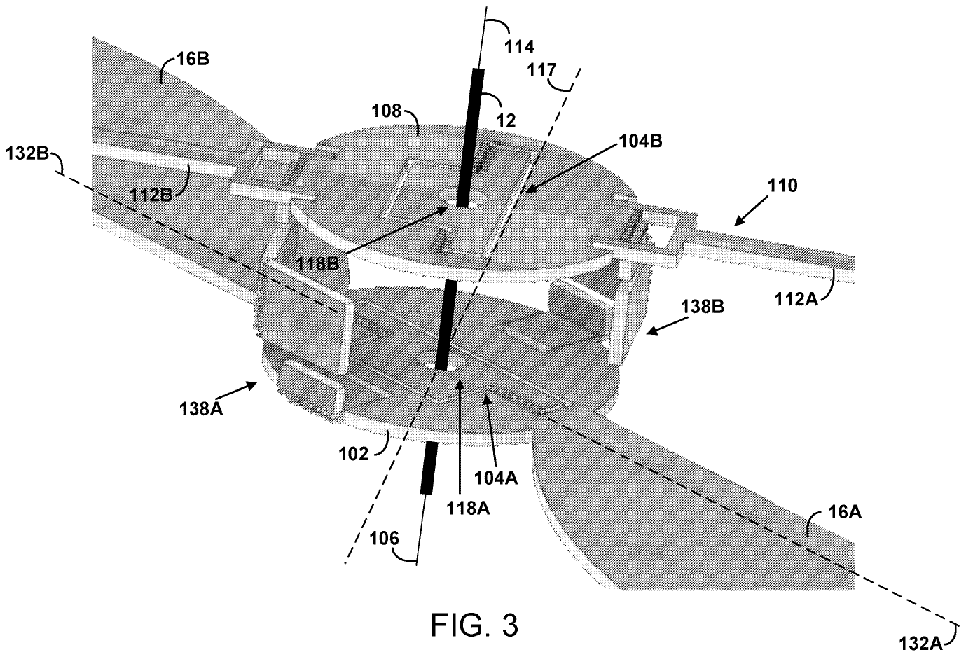

FIG. 3 is a close up perspective view of the apparatus 100.

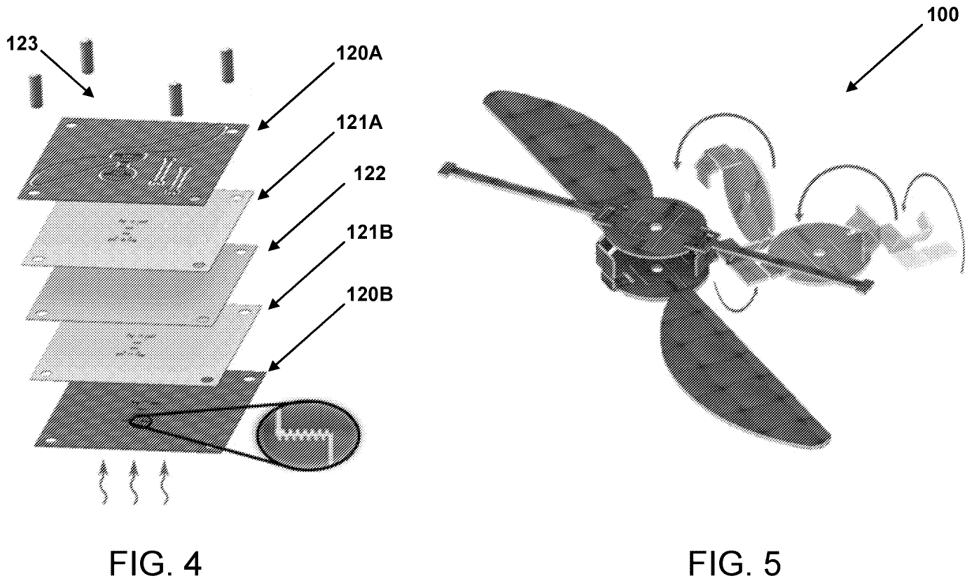

FIG. 4 is an exploded view of a composite laminate structure 123. Many of the components of the apparatus 100 are formed of the composite laminate structure 123. The composite laminate structure 123 includes a fibrous sheet 120A, an adhesive layer 121A, a flexible film 122, an adhesive layer 121B, and a fibrous sheet 120B formed into a sandwich structure. The flexible film 122 is adhered to and positioned between the fibrous sheet 120A and the fibrous sheet 120B via the adhesive layer 121A and the adhesive layer 121B.

The fibrous sheet 120A and the fibrous sheet 120B each comprise a thermoplastic matrix material embedded with carbon fibers. For example, the fibrous sheet 120A and the fibrous sheet 120B could each be 95 μm thick and each comprise four layers of 23 gram per square meter (GSM) carbon fiber arranged in a 4-ply 0°-45°-315°-0° stack.

The flexible film 122 can be formed of a polymide sheet that is 7.5 μm or 12.5 μm thick.

The adhesive layer 121A and the adhesive layer 121B could each be formed of acrylic adhesive (e.g., FR1500 Pyralux®).

Thus, the rotor plate 102, the rotor blades 16, the flybar 110, the fly bar plate 108, the linkage 138A, and the linkage 138B all include the fibrous sheet 120A, the adhesive layer 121A, the flexible film 122, the adhesive layer 121B, and the fibrous sheet 120B, that is, the composite laminate structure 123. The fibrous sheet 120A, the adhesive layer 121A, the flexible film 122, the adhesive layer 121B, and the fibrous sheet 120B are fused together with pressure and heat to form the composite laminate structure 123.

FIG. 5 shows how portions of the composite laminate structure 123 are cut and folded to form the apparatus 100.

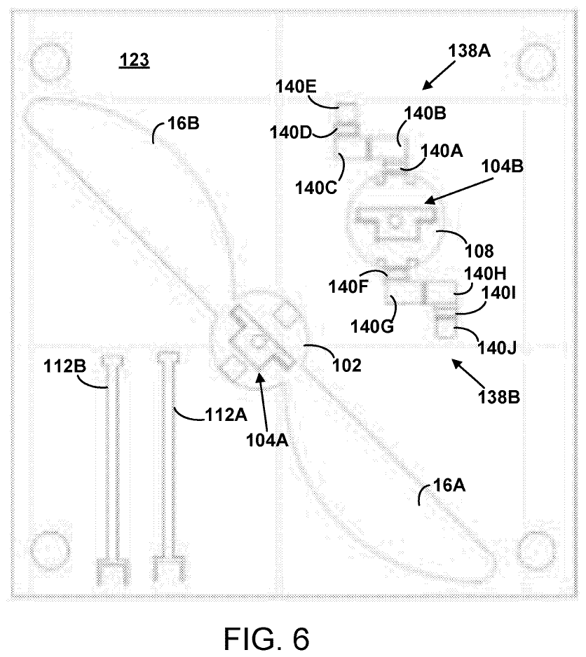

FIG. 6 shows cut lines for components of the apparatus 100 that are cut from the composite laminate structure 123. As shown, the linkage 138A, the linkage 138B, and the fly bar plate 108 are formed of a singular portion of the composite laminate structure 123. Additionally, the rotor plate 102, the rotor blade 16A and the rotor blade 16B are formed of a singular portion of the composite laminate structure 123.

The method of forming the apparatus 100 includes forming the rotor plate 102, the rotor blade 16A, and the rotor blade 16B as a first singular structure from the composite laminate structure 123 by cutting an outline through the fibrous sheet 120A, the fibrous sheet 120B, and the flexible film 122.

The method also includes forming the flexure hinge 104A within the rotor plate 102 by cutting an outline through the fibrous sheet 120A and the fibrous sheet 120B and leaving the flexible film 122 intact. The hole 118A is formed by cutting out the fibrous sheet 120A, the fibrous sheet 120B, and the flexible film 122.

The method also includes forming the flybar section 112A from the composite laminate structure 123 by cutting an outline through the fibrous sheet 120A, the fibrous sheet 120B, and the flexible film 122.

The method also includes forming the flybar section 112B from the composite laminate structure 123 by cutting an outline through the fibrous sheet 120A, the fibrous sheet 120B, and the flexible film 122.

The method also includes forming the flybar plate 108, the linkage 138A, and the linkage 138B as a second singular structure by cutting an outline through the fibrous sheet 120A, the fibrous sheet 120B, and the flexible film 122.

The method also includes forming the flexure hinge 104B by cutting an outline through the fibrous sheet 120A and the fibrous sheet 120B and leaving the flexible film 122 intact. The hole 118B is formed by cutting out the fibrous sheet 120A, the fibrous sheet 120B, and the flexible film 122.

The method also includes forming the linkage 138A and the linkage 138B by cutting through the fibrous sheet 120A and the fibrous sheet 120B and leaving the flexible film 122 intact multiple times such that the flexible film 122 is the sole connection between the link 140A and the link 140B, the link 140B and the link 140C, the link 140C and the link 140D, the link 140D and the link 140E, the link 140F and the link 140G, the link 140G and the link 140H, the link 140H and the link 140I, and the link 140I and the link 140J.

The method also includes adhering (e.g., with cyanoacrylate glue) the flybar section 112A and the fly bar section 112B to opposite ends of the flybar plate 108.

The method also includes folding the linkage 138A and the linkage 138B at the points connected only by the flexible film 122 as shown in FIG. 5 and adhering the linkage 138A and the linkage 138B to opposite ends of the rotor plate 102. That is, the link 140E is adhered to the rotor plate 102 and the link 140J is adhered to the rotor plate 102 at an opposite end.

Thus, the link 140A is flexibly coupled to the flybar plate 108 via a first portion of the flexible film 122. The link 140B is flexibly coupled to the link 140A via a second portion of the flexible film 122. The link 140C is coupled at a fixed angle to the link 140B (see FIG. 2 or 3) via adhesive and a third portion of the flexible film 122. The link 140D is flexibly coupled to the link 140C via a fourth portion of the flexible film 122. The link 140E is flexibly coupled to the link 140D via a fifth portion of the flexible film 122 and adhered to the rotor plate 102.

The link 140F is flexibly coupled to the flybar plate 108 via a sixth portion of the flexible film 122. The link 140G is flexibly coupled to the link 140F via a seventh portion of the flexible film 122. The link 140H is coupled at a fixed angle to the link 140G (see FIG. 2 or 3) via adhesive and an eighth portion of the flexible film 122. The link 140I is flexibly coupled to the link 140H via a ninth portion of the flexible film 122. The link 140J is flexibly coupled to the link 140I via a tenth portion of the flexible film 122 and adhered to the rotor plate 102.

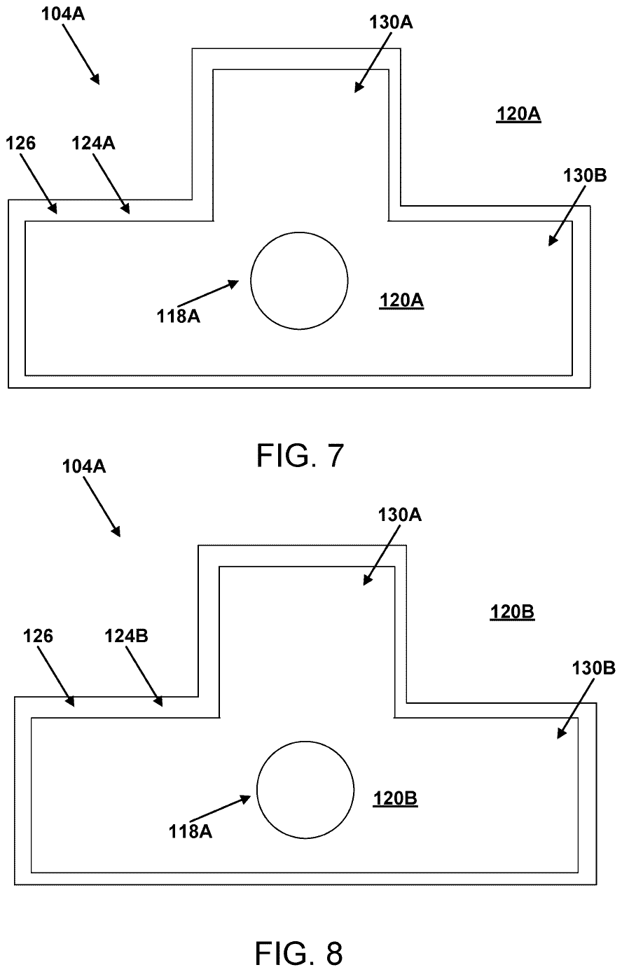

FIG. 7 is a top schematic view of the flexure hinge 104A and FIG. 8 is a bottom schematic view of the flexure hinge 104A. The rotor plate 102 comprises a gap 124A formed in the fibrous sheet 120A and a gap 124B formed in the fibrous sheet 120B opposite the gap 124A. The flexure hinge 104A comprises a portion 126 of the flexible film 122 that is between the gap 124A and the gap 124B.

In some examples, the fibrous sheet 120A and the fibrous sheet 120B have castellated edges that form the gap 124A and the gap 124B.

In some examples, the gap 124A forms a first closed loop of separation within the fibrous sheet 120A and the gap 124B forms a second closed loop of separation within the fibrous sheet 120B.

As shown, the hole 118A is positioned within the first closed loop and the second closed loop formed by the gap 124A and the gap 124B.

Furthermore, the gap 124A and the gap 124B define a portion 130A of the flexure hinge 104A and a portion 130B of the flexure hinge 104A that is wider than the portion 130A along the chord 132A and the chord 132B.

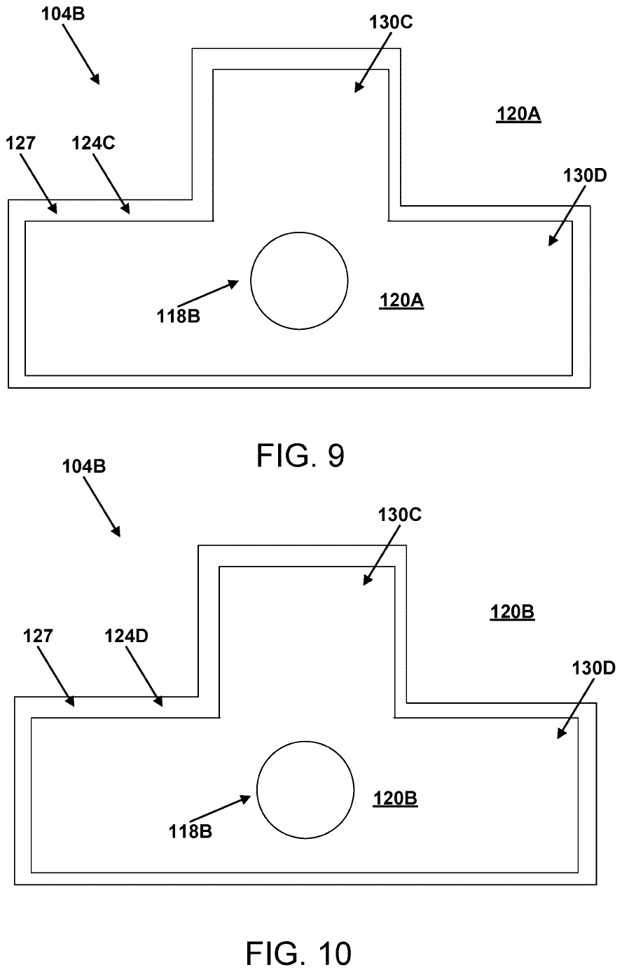

FIG. 9 is a top schematic view of the flexure hinge 104B and FIG. 10 is a bottom schematic view of the flexure hinge 104B. The fly bar plate 108 comprises a gap 124C formed in the fibrous sheet 120A and a gap 124D formed in the fibrous sheet 120B opposite the gap 124C. The flexure hinge 104B comprises a portion 127 of the flexible film 122 that is between the gap 124C and the gap 124D.

In some examples, the fibrous sheet 120A and the fibrous sheet 120B have castellated edges that form the gap 124C and the gap 124D.

In some examples, the gap 124C forms a first closed loop of separation within the fibrous sheet 120A and the gap 124D forms a second closed loop of separation within the fibrous sheet 120B.

As shown, the hole 118B is positioned within the first closed loop and the second closed loop formed by the gap 124C and the gap 124D.

Furthermore, the gap 124C and the gap 124D define a portion 130C of the flexure hinge 104B and a portion 130D of the flexure hinge 104B that is wider than the portion 130C perpendicular to the fly bar 110.

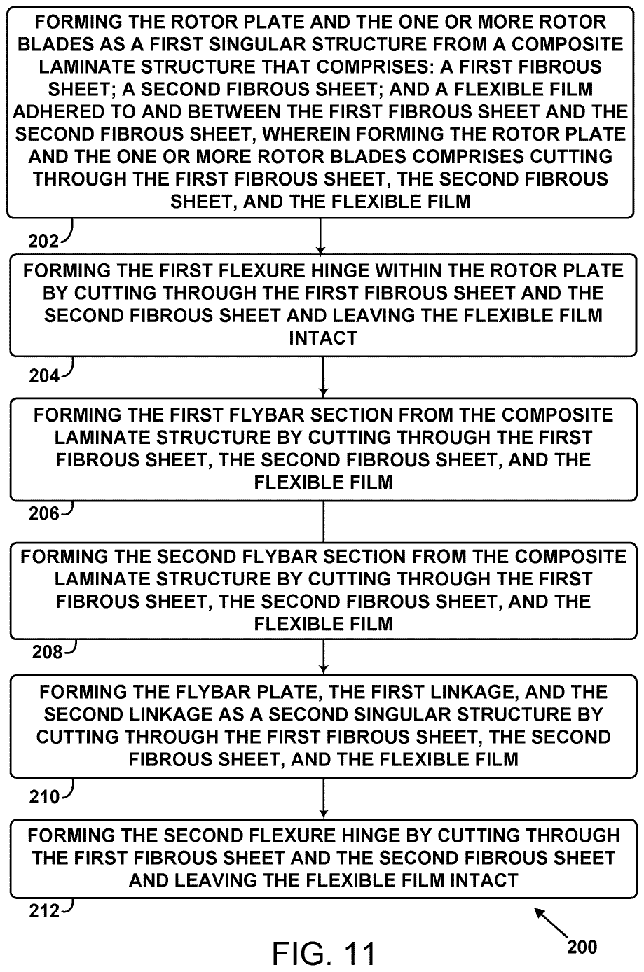

FIG. 11 is a block diagram of a method 200. As shown in FIG. 11, the method 200 includes one or more operations, functions, or actions as illustrated by blocks 202, 204, 206, 208, 210, and 212. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes forming the rotor plate 102 and the one or more rotor blades 16 as a first singular structure from the composite laminate structure 123 that comprises: the fibrous sheet 120A; the fibrous sheet 120B; and the flexible film 122 adhered to and between the fibrous sheet 120A and the fibrous sheet 120B, wherein forming the rotor plate 102 and the one or more rotor blades 16 comprises cutting through the fibrous sheet 120A, the fibrous sheet 120B, and the flexible film 122.

At block 204, the method 200 includes forming the flexure hinge 104A within the rotor plate 102 by cutting through the fibrous sheet 120A and the fibrous sheet 120B and leaving the flexible film 122 intact. Functionality related to block 204 is described above with reference to FIGS. 4-6.

At block 206, the method 200 includes forming the flybar section 112A from the composite laminate structure 123 by cutting through the fibrous sheet 120A, the fibrous sheet 120B, and the flexible film 122. Functionality related to block 206 is described above with reference to FIGS. 4-6.

At block 208, the method 200 includes forming the flybar section 112B from the composite laminate structure 123 by cutting through the fibrous sheet 120A, the fibrous sheet 120B, and the flexible film 122. Functionality related to block 208 is described above with reference to FIGS. 4-6.

At block 210, the method 200 includes forming the flybar plate 108, the linkage 138A, and the linkage 138B as a second singular structure by cutting through the fibrous sheet 120A, the fibrous sheet 120B, and the flexible film 122. Functionality related to block 210 is described above with reference to FIGS. 4-6.

At block 212, the method 200 includes forming the flexure hinge 104B by cutting through the fibrous sheet 120A and the fibrous sheet 120B and leaving the flexible film 122 intact. Functionality related to block 212 is described above with reference to FIGS. 4-6.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. An apparatus comprising:
a rotor plate comprising a first flexure hinge configured for coupling to a drive shaft;
one or more rotor blades extending from the rotor plate, wherein the first flexure hinge is configured to allow a first rotation axis of the one or more rotor blades to move out of alignment with the drive shaft;
a flybar plate comprising a second flexure hinge configured for coupling to the drive shaft; and
a flybar comprising a first flybar section and a second flybar section both extending from the flybar plate, wherein the second flexure hinge is configured to allow a second rotation axis of the flybar to move out of alignment with the drive shaft.

2-3. (canceled)

4. The apparatus of claim 1, wherein the one or more rotor blades are each rotationally offset from the flybar at an angle that is greater than or equal to 0 degrees and less than or equal to 90 degrees.

5-6. (canceled)

7. The apparatus of claim 1, wherein the rotor plate comprises:
a first fibrous sheet;
a second fibrous sheet; and
a flexible film adhered to and between the first fibrous sheet and the second fibrous sheet.

8. The apparatus of claim 7, wherein the rotor plate comprises a first gap formed in the first fibrous sheet and a second gap formed in the second fibrous sheet opposite the first gap, wherein the first flexure hinge comprises a portion of the flexible film that is between the first gap and the second gap.

9. The apparatus of claim 8, wherein the first fibrous sheet and the second fibrous sheet have castellated edges that form the first gap and the second gap.

10-16. (canceled)

17. The apparatus of claim 1, wherein the flybar plate comprises:
a first fibrous sheet;
a second fibrous sheet; and
a flexible film adhered between the first fibrous sheet and the second fibrous sheet.

18. The apparatus of claim 17, wherein the flybar plate comprises a first gap formed in the first fibrous sheet and a second gap formed in the second fibrous sheet opposite the first gap, wherein the second flexure hinge comprises a portion of the flexible film that is between the first gap and the second gap.

19. The apparatus of claim 18, wherein the first fibrous sheet and the second fibrous sheet have castellated edges that form the first gap and the second gap.

20-21. (canceled)

22. The apparatus of claim 18, wherein the first gap and the second gap define a first portion of the second flexure hinge and a second portion of the second flexure hinge that is wider than the first portion perpendicular to the flybar.

23-24. (canceled)

25. The apparatus of claim 1, further comprising a linkage that couples the flybar plate to the rotor plate such that tilting of the second rotation axis with respect to the drive shaft results in tilting of the first rotation axis with respect to the drive shaft, such that an angle of attack of the one or more rotor blades can vary as the drive shaft rotates.

26. The apparatus of claim 25, wherein the tilting of the first rotation axis is configured to occur within a first plane that contains the drive shaft and the tilting of the second rotation axis is configured to occur within a second plane that contains the drive shaft and intersects the first plane.

27. The apparatus of claim 26, wherein the first plane and the second plane form an angle that is greater than zero and less than or equal to 90 degrees.

28-29. (canceled)

30. The apparatus of claim 25, wherein the linkage comprises:
a first fibrous sheet;
a second fibrous sheet; and
a flexible film adhered between the first fibrous sheet and the second fibrous sheet.

31. The apparatus of claim 30, wherein the linkage comprises:
a first link flexibly coupled to the flybar plate via a first portion of the flexible film;
a second link flexibly coupled to the first link via a second portion of the flexible film;
a third link coupled at a fixed angle to the second link via adhesive and a third portion of the flexible film;
a fourth link flexibly coupled to the third link via a fourth portion of the flexible film; and
a fifth link that is flexibly coupled to the fourth link via a fifth portion of the flexible film and adhered to the rotor plate.

32. The apparatus of claim 25, wherein the linkage is a first linkage, the apparatus further comprising a second linkage opposite the first linkage, wherein the second linkage couples the flybar plate to the rotor plate such that tilting of the second rotation axis with respect to the drive shaft results in tilting of the first rotation axis with respect to the drive shaft.

33-34. (canceled)

35. The apparatus of claim 32, wherein the second linkage comprises:
a first fibrous sheet;
a second fibrous sheet; and
a flexible film adhered between the first fibrous sheet and the second fibrous sheet.

36. The apparatus of claim 35, wherein the second linkage comprises:
a sixth link flexibly coupled to the flybar plate via a sixth portion of the flexible film;
a seventh link flexibly coupled to the sixth link via a seventh portion of the flexible film;
an eighth link coupled at a fixed angle to the seventh link via adhesive and an eighth portion of the flexible film;
a ninth link flexibly coupled to the eighth link via a ninth portion of the flexible film; and
a tenth link that is flexibly coupled to the ninth link via a tenth portion of the flexible film and adhered to the rotor plate.

37. An aircraft comprising:
the drive shaft of claim 1;
the one or more rotor blades of claim 1, attached to the drive shaft;
an actuator configured to rotate the drive shaft; and
the apparatus of claim 1, wherein the drive shaft is coupled to the rotor plate via the first flexure hinge and the drive shaft is coupled to the flybar plate via the second flexure hinge.

38. A method of manufacturing the apparatus of claim 1, the method comprising:
forming the rotor plate and the one or more rotor blades as a first singular structure from a composite laminate structure that comprises:
a first fibrous sheet;
a second fibrous sheet; and
a flexible film adhered to and between the first fibrous sheet and the second fibrous sheet, wherein forming the rotor plate and the one or more rotor blades comprises cutting through the first fibrous sheet, the second fibrous sheet, and the flexible film;
forming the first flexure hinge within the rotor plate by cutting through the first fibrous sheet and the second fibrous sheet and leaving the flexible film intact;
forming the first flybar section from the composite laminate structure by cutting through the first fibrous sheet, the second fibrous sheet, and the flexible film;
forming the second flybar section from the composite laminate structure by cutting through the first fibrous sheet, the second fibrous sheet, and the flexible film;
forming the flybar plate, a first linkage, and a second linkage as a second singular structure by cutting through the first fibrous sheet, the second fibrous sheet, and the flexible film; and
forming the second flexure hinge by cutting through the first fibrous sheet and the second fibrous sheet and leaving the flexible film intact.

39. (canceled)

40. The method of claim 38, wherein forming the first linkage and the second linkage further comprises cutting through the first fibrous sheet and the second fibrous sheet and leaving the flexible film intact.

41-84. (canceled)
